(19) United States
(12) Patent Application Publication
(10) Pub. No.: US 2009/0048406 A1
(43) Pub. Date: Feb. 19, 2009

(54) PROCESS FOR PREPARING CONTINUOUSLY VARIABLE-COMPOSITION COPOLYMERS

(75) Inventors: Nadine Iroff, Perkiomenville, PA (US); Peter Moore, Philadelphia, PA (US)

Correspondence Address: OBLON, SPIVAK, MCCLELLAND MAIER & NEUSTADT, P.C., 1940 DUKE STREET, ALEXANDRIA, VA, 22314, US

(73) Assignee: EVONIK ROHMAX ADDITIVES GMBH, Darmstadt (DE)

(21) Appl. No.: 12/172,382

(22) Filed: Jul. 14, 2008

Related U.S. Application Data
(60) Provisional application No. 60/949,279, filed on Jul. 12, 2007.

(51) Int. Cl. C08F 2/01; C08F 2/06

(52) U.S. Cl. 526/60; 526/65; 526/66; 526/61

(57) ABSTRACT

A continuously variable composition copolymer is prepared in a reaction system, by (a) providing a reaction vessel comprising a first monomer composition; (b) providing a feed vessel comprising a second monomer composition; (c) initiating a polymerization reaction in the reaction vessel; (d) continuing the polymerization reaction during the gradual addition of the second monomer composition from the feed vessel to the reaction vessel, wherein the gradual addition of the second monomer composition is performed such that the continuously variable composition copolymer is obtained; (e) maintaining the polymerization until at least 90% of the total monomer composition has been converted to the copolymer; wherein the copolymer has a weight average molecular weight from 10,000 to 1,000,000; wherein the copolymer is soluble in lubricating oil, wherein the monomers of the first monomer composition provided in the reaction vessel comprise at least 50% by weight of all the monomers used to prepare the copolymer.

### BACKGROUND OF THE INVENTION

1. Field of the Invention

The present invention relates to an improved process for preparing a continuously variable-composition copolymer by effecting gradual changes in monomer composition during the polymerization process.

2. Discussion of the Background

The behaviour of petroleum oil formulations under cold flow conditions is greatly influenced by the presence of paraffins (waxy materials) that crystallize out of the oil upon cooling; these paraffins significantly reduce the fluidity of the oils at low temperature conditions. Polymeric flow improvers, known as pour point depressants, have been developed to effectively reduce the “pour point” or solidifying point of oils under specified conditions (that is, the lowest temperature at which the formulated oil remains fluid). Pour point depressants are effective at very low concentrations, for example, between 0.05 and 1 percent by weight in the oil. It is believed that the pour point depressant material incorporates itself into the growing paraffin crystal structure, effectively hindering further growth of the crystals and the formation of extended crystal agglomerates, thus allowing the oil to remain fluid at lower temperatures than otherwise would be possible.

One limitation of the use of pour point depressant polymers is that petroleum base oils from different sources contain varying types of waxy or paraffin materials and not all polymeric pour point depressants are equally effective in reducing the pour point of different petroleum oils, that is, a polymeric pour point depressant may be effective for one type of oil and ineffective for another. It would be desirable for a single pour point depressant polymer to be useful in a wide variety of petroleum oils.

One approach to solving this problem is disclosed in “Depression Effect of Mixed Pour Point Depressants for Crude Oil” by B. Zhao, J. Shenyang, Inst. Chem. Tech., 8(3), 228-230 (1994), where improved pour point performance on two different crude oil samples was obtained by using a physical mixture of two different conventional pour point depressants when compared to using the pour point depressants individually in the oils. Similarly, U.S. Pat. No. 5,281,329 and European Patent Application EP 140,274 disclose the use of physical mixtures of different polymeric additives to achieve improved pour point properties when compared to using each polymer additive alone in lubricating oils.

U.S. Pat. No. 4,048,413 discloses a process for the preparation of uniform-composition copolymers by controlling the ratio and rate of addition of the monomers added to a polymerizing mixture of the monomers to offset the natural differences in reactivities of the individual monomers that would normally lead to compositional “drift” during conventional polymerizations. There is no disclosure in U.S. Pat. No. 4,048,413 of controlling the ratio and rate of addition of monomers to a polymerization mixture to provide a continuously changing- or continuously variable-composition copolymer.

Document WO 2006/015751 presents a method for free radical polymerization where a monomer mixture is heated to an elevated temperature and initiator is added dropwise over multiple steps, with a greater rate of initiator addition in the latter steps.

None of these previous approaches provides good low temperature fluidity when a single polymer additive is used in a wide range of lubricating oil formulations.

Furthermore, U.S. Pat. No. 6,140,431 presents a process to produce continuously variable-composition methacrylate copolymers by forming two different reaction mixtures, each mixture containing polymerization free radical initiators and gradually adding either (a) reaction mix “A” to a mixing vessel while reaction mix “B” is being added to mix “A” and the content of the mixing vessel is being fed to the reaction vessel or (b) reaction mix “A” to the reactor at one feed profile while reaction mix “B” is also being added to the reactor at a different feed profile. U.S. Pat. No. 6,140,431 does not disclose to provide a high amount of a specific monomer mixture to the reaction vessel before starting the addition of another monomer mixture.

The copolymers obtainable according to U.S. Pat. No. 6,140,431 show a good efficiency as pour point depressants. However, the process is difficult to control and needs a high investment. Based on the complexity of the process, the risk of mistakes is high.

### BRIEF DESCRIPTION OF DRAWINGS

FIG. 1 shows that one can estimate the instantaneous copolymer compositions as a function of polymer formation based on the first monomer composition and the second monomer composition and feed rate. FIG. 1 provides such an estimate for the case where the starting monomer composition of 71.4 parts with A₁=LMA=30 wt. % and B₁=SMA=70 wt. % and the second monomer composition of 28.6 parts with A₂=LMA=100 wt. %.

FIG. 2 shows the effect of the monomer feed time on the instantaneous copolymer composition.

### DETAILED DESCRIPTION OF THE INVENTION

It is an object of the present invention to provide an improved process for preparing copolymers having a continuously variable-composition. A further object of the present invention is to provide a process being easy to control. Additionally, the process should be performed at a low risk of mistakes. Furthermore, it is an object of the present invention to provide a simple and inexpensive process for preparing copolymers having a continuously variable-composition.

The most common mistakes to be avoided are as follows. The process as described, for example, in U.S. Pat. No. 6,140,431 and in Comparative Example 1, involves the preparation of two monomer mixes, which are then added to a reaction vessel concurrently while varying the rate of feed of each of these mixes. Mistakes in either the composition of these mixes or the relative rates of feed of each mix can result in a polymer being formed which does not provide the desired low temperature performance required in the product. Interruption of feed of one of these mixes will also produce a polymer which does not meet the desired performance.

In the present invention, only a single monomer feed is being used. Thus, there is less opportunity for interruption of this feed. In addition, less equipment is required to implement the process of the present invention.

These as well as other not explicitly mentioned tasks, which, however, can easily be derived or developed from the introductory part, are achieved by the process for preparing continuously variable composition copolymers according to the claims and as described below. Expedient modifications of the process in accordance with the invention are described in the dependent claims.

The present invention relates to an improved process for preparing a continuously variable-composition copolymer by effecting gradual changes in monomer composition during the polymerization process. An example of application of this process is the preparation of poly(meth)acrylate copolymers that have improved lubricating oil additive properties, for example, as pour point depressants or viscosity index improvers, when compared to related polymer additives made by conventional means.

The first embodiment of the present invention includes a process for preparing a continuously variable composition copolymer in a reaction system, comprising:

(a) providing a reaction vessel comprising a first monomer composition;

(b) providing a feed vessel comprising a second monomer composition;

(c) initiating a polymerization reaction in said reaction vessel;

(d) continuing the polymerization reaction during the gradual addition of said second monomer composition from said feed vessel to said reaction vessel, wherein the gradual addition of the second monomer composition is performed such that said continuously variable composition copolymer is obtained;

(e) maintaining said polymerization until at least 90% of the total monomer composition has been converted to said copolymer;

wherein said copolymer has a weight average molecular weight from 10,000 to 1,000,000;

wherein said copolymer is soluble in lubricating oil,

wherein the monomers of said first monomer composition provided in the reaction vessel comprise at least 50% by weight of all the monomers used to prepare said copolymer.

The process of the invention provides an improved process for preparing copolymers having a continuously variable-composition. The process of the present invention can easily be controlled. Therefore, the process can be performed at a low risk of mistakes. Furthermore, the process to prepare continuously variable polymer compositions is very simple and inexpensive. This is very important with regard to the return of investment and up scaling of a plant for the production of the copolymers mentioned above. Additionally, the process of the present invention needs a reduced amount of initiator used. Moreover, the invention provides an improved process temperature control, and increased process reliability. Furthermore, the copolymers prepared by the process of the present invention have the aforementioned desired combination of lubricating oil properties in a single polymer additive.

According to the process of the present invention, a first monomer composition is provided in a reaction vessel. Additionally, a second monomer composition is provided in a feed vessel. The expression “reaction vessel” means the reactor in which the polymerization reaction takes place. Useful reaction vessels are well known in the art. The term “feed vessel” expresses a reservoir from which the second monomer mixture is added to the reaction vessel.

The first monomer composition is different than the second monomer composition. For example, the first monomer composition may comprise a monomer which is not present in the second monomer composition or the second monomer composition may comprise a monomer which is not present in the first monomer composition. Additionally, both monomer compositions may comprise the same monomers. However, the monomers are present in different amounts.

According to a preferred embodiment the first monomer composition can contain one or multiple polymerizable monomers, identified as A₁, B₁, C₁, . . . X₁, where the sum of the weight percentages of each polymerizable monomer adds up to 100. The second monomer composition can also contains one or multiple polymerizable monomers, identified as A₂, B₂, C₂, . . . Xₙ, where the sum of the weight percentages of each polymerizable monomer adds up to 100. Similarly, additional monomer composition can be used as additional feed compositions. In this way, continuously variable polymer compositions can be prepared where the initial polymer compositions are equivalent to the first monomer composition, identified as A₁, B₁, C₁, . . . X₁. The polymer composition then varies over the course of the reaction starting at the time that the second monomer composition feed is begun, such that the average composition can be defined by the equations:

A_{avg}=Σ(Aₙ*Wₙ)/ΣWₙ

B_{avg}=Σ(Bₙ*Wₙ)/ΣWₙ

C_{avg}=Σ(Cₙ*Wₙ)/ΣWₙ

X_{avg}=Σ(Xₙ*Wₙ)/ΣWₙ

where Xₙ is the weight percent of each individual monomer (X) in each monomer composition (n) and Wₙ is the total weight of monomer in that monomer composition.

The final polymer composition produced is equivalent to the unreacted monomer composition present in the reaction vessel at the point where all monomer feeds are completed. Thus, the range of compositions in the final polymer can be estimated as ranging between:

A_{avg}+[A_{avg}−A₁] and A_{avg}−[A_{avg}−A₁]

B_{avg}+[B_{avg}−B₁] and B_{avg}−[B_{avg}−B₁]

C_{avg}+[C_{avg}−C₁] and C_{avg}−[C_{avg}−C₁]

X_{avg}+[X_{avg}−X₁] and X_{avg}−[X_{avg}−X₁]

where [A_{avg}-A₁] is the absolute value of the difference between the starting composition (A₁) and the average composition (A_{avg}) for monomer A, with equivalent definitions for the other monomers.

According to a preferred embodiment the concentration of at least one monomer component in the first monomer composition differs preferably in at least 5%, more preferably at least 10% and more preferably at least 5-50% from the concentration of the same monomer component in the second monomer composition. The difference between the first and second monomer compositions can be defined by the sum of the differences of each individual monomer and can be defined by the equation:

X_{Diff}=Σ|X₁−X₂| where X₁ the weight percent of each individual monomer in the first monomer composition and X₂ the weight percent of each individual monomer in the second monomer composition. In the preferred embodiment, the value for X_{Diff} can range from 5% to 200% and more preferably range from 10% to 100%. The value for X_{Diff} includes all values and subvalues therebetween, especially including 10, 20, 30, 40, 50, 60, 70, 80, 90, 100, 110, 120, 130, 140, 150, 160, 170, 180 and 190%.

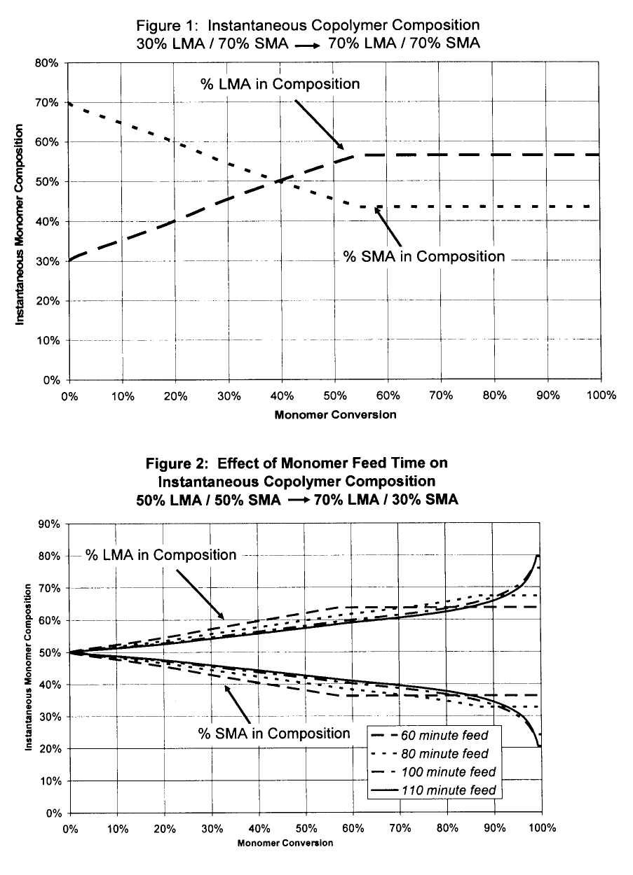

Using standard polymerization kinetics, one can estimate the instantaneous copolymer compositions as a function of polymer formation based on the first monomer composition and the second monomer composition and feed rate. FIG. 1 provides such an estimate for the case where the starting monomer composition of 71.4 parts with A₁=LMA=30 wt. % and B₁═SMA=70 wt. % and the second monomer composition of 28.6 parts with A₂=LMA=100 wt. % (LMA=lauryl−myristyl methacrylate, SMA=cetyl−stearyl methacrylate).

In the preferred embodiment, the absolute range of compositions of at least one of the monomers is at least 5%, with a more preferable range of 5-30%, and a maximum range as high as 100%. The absolute range of compositions of at least one of the monomers includes all values and subvalues therebetween, especially including 10, 20, 30, 40, 50, 60, 70, 80 and 90%. Unless otherwise specified, % refers to % by weight.

There is no limitation on the number of monomers or monomer types used to prepare continuously variable-composition copolymers of the present invention. Monomers used in practicing the process of the present invention may be any monomers capable of polymerizing with comonomers and which are relatively soluble in the copolymer formed. Preferably the monomers are monoethylenically unsaturated monomers. Polyethylenically unsaturated monomers which lead to crosslinking during the polymerization are generally undesirable. Polyethylenically unsaturated monomers which do not lead to crosslinking or only crosslink to a small degree, for example, butadiene, are also satisfactory comonomers.

One class of suitable monoethylenically unsaturated monomers is vinylaromatic monomers that includes, for example, styrene, α-methylstyrene, vinyltoluene, ortho-, meta- and para-methylstyrene, ethylvinylbenzene, vinylnaphthalene and vinylxylenes. The vinylaromatic monomers can also include their corresponding substituted counterparts, for example, halogenated derivatives, that is, containing one or more halogen groups, such as fluorine, chlorine or bromine; and nitro, cyano, alkoxy, haloalkyl, carbalkoxy, carboxy, amino and alkylamino derivatives.

Another class of suitable monoethylenically unsaturated monomers is nitrogen-containing ring compounds, for example, vinylpyridine, 2-methyl-5-vinylpyridine, 2-ethyl-5-vinylpyridine, 3-methyl-5-vinylpyridine, 2,3-dimethyl-5-vinylpyridine, 2-methyl-3-ethyl-5-vinylpyridine, methyl-substituted quinolines and isoquinolines, 1-vinylimidazole, 2-methyl-1-vinylimidazole, N-vinylcapro-lactam, N-vinylbutyrolactam and N-vinylpyrrolidone.

Another class of suitable monoethylenically unsaturated monomers is ethylene and substituted ethylene monomers, for example: α-olefins such as propylene, isobutylene and long chain alkyl α-olefins (such as (C₁₀-C₂₀)alkyl α-olefins); vinyl alcohol esters such as vinyl acetate and vinyl stearate; vinyl halides such as vinyl chloride, vinyl fluoride, vinyl bromide, vinylidene chloride, vinylidene fluoride and vinylidene bromide; vinyl nitriles such as acrylonitrile and methacrylonitrile; (meth)acrylic acid and derivatives such as corresponding amides and esters; maleic acid and derivatives such as corresponding anhydride, amides and esters; fumaric acid and derivatives such as corresponding amides and esters; itaconic and citraconic acids and derivatives such as corresponding anhydrides, amides and esters.

A preferred class of (meth)acrylic acid derivatives is represented by alkyl (meth)acrylate, substituted (meth)acrylate and substituted (meth)acrylamide monomers. Each of the monomers can be a single monomer or a mixture having different numbers of carbon atoms in the alkyl portion. Preferably, the monomers are selected from the group consisting of (C₁-C₂₄)alkyl (meth)acrylates, hydroxy(C₂-C₆)alkyl (meth)acrylates, dialkylamino(C₂-C₆)alkyl (meth)acrylates and dialkylamino(C₂-C₆)alkyl (meth)acrylamides. The alkyl portion of each monomer can be linear or branched.

Particularly preferred polymers useful in the process of the present invention are the poly(meth)acrylates derived from the polymerization of alkyl (meth)acrylate monomers. As used herein, the term “alkyl (meth)acrylate” refers to either the corresponding acrylate or methacrylate ester; similarly, the term “(meth)acrylic” refers to either the corresponding acrylic or methacrylic acid and derivatives. Examples of the alkyl (meth)acrylate monomer where the alkyl group contains from 1 to 6 carbon atoms (also called the “low-cut” alkyl (meth)acrylates), are methyl methacrylate (MMA), methyl and ethyl acrylate, propyl methacrylate, butyl methacrylate (BMA) and acrylate (BA), isobutyl methacrylate (IBMA), hexyl and cyclohexyl methacrylate, cyclohexyl acrylate and combinations thereof. Preferred low-cut alkyl methacrylates are methyl methacrylate and butyl methacrylate.

Examples of the alkyl (meth)acrylate monomer where the alkyl group contains from 7 to 15 carbon atoms (also called the “mid-cut” alkyl (meth)acrylates), are 2-ethylhexyl acrylate (EHA), 2-ethylhexyl methacrylate, octyl methacrylate, decyl methacrylate, isodecyl methacrylate (IDMA, based on branched (C10)alkyl isomer mixture), undecyl methacrylate, dodecyl methacrylate (also known as lauryl methacrylate), tridecyl methacrylate, tetradecyl methacrylate (also known as myristyl methacrylate), pentadecyl methacrylate and combinations thereof. Also useful are: dodecyl-pentadecyl methacrylate (DPMA), a mixture of linear and branched isomers of dodecyl, tridecyl, tetradecyl and pentadecyl methacrylates; and lauryl-myristyl methacrylate (LMA), a mixture of dodecyl and tetradecyl methacrylates. The preferred mid-cut alkyl methacrylates are lauryl-myristyl methacrylate, dodecyl-pentadecyl methacrylate and isodecyl methacrylate.

Examples of the alkyl (meth)acrylate monomer where the alkyl group contains from 16 to 24 carbon atoms (also called the “high-cut” alkyl (meth)acrylates), are hexadecyl methacrylate (also known as cetyl methacrylate), heptadecyl methacrylate, octadecyl methacrylate (also known as stearyl methacrylate), nonadecyl methacrylate, eicosyl methacrylate, behenyl methacrylate and combinations thereof. Also useful are: cetyl-eicosyl methacrylate (CEMA), a mixture of hexadecyl, octadecyl, and eicosyl methacrylate; and cetyl-stearyl methacrylate (SMA), a mixture of hexadecyl and octadecyl methacrylate. The preferred high-cut alkyl methacrylates are cetyl-eicosyl methacrylate and cetyl-stearyl methacrylate.

The mid-cut and high-cut alkyl (meth)acrylate monomers described above are generally prepared by standard esterification procedures using technical grades of long chain aliphatic alcohols, and these commercially available alcohols are mixtures of alcohols of varying chain lengths containing between 10 and 15 or 16 and 20 carbon atoms in the alkyl group. Consequently, for the purposes of this invention, alkyl (meth)acrylate is intended to include not only the individual alkyl (meth)acrylate product named, but also to include mixtures of the alkyl (meth)acrylates with a predominant amount of the particular alkyl (meth)acrylate named. The use of these commercially available alcohol mixtures to prepare (meth)acrylate esters results in the LMA, DPMA, SMA and CEMA monomer types described above. Preferred (meth)acrylic acid derivatives useful in the process of the present invention are methyl methacrylate, butyl methacrylate, isodecyl methacrylate, lauryl-myristyl methacrylate, dodecyl-pentadecyl methacrylate, cetyl-eicosyl methacrylate and cetyl-stearyl methacrylate.

For the purposes of the present invention, it is understood that copolymer compositions representing combinations of the monomers from aforementioned classes of monomers may be prepared using the process of the present invention. For example, copolymers of alkyl (meth)acrylate monomers and vinylaromatic monomers, such as styrene; copolymers of alkyl (meth)acrylate monomers and substituted (meth)acrylamide monomers, such as N,N-dimethylaminopropyl methacrylamide; copolymers of alkyl (meth)acrylate monomers and monomers based on nitrogen-containing ring compounds, such as N-vinylpyrrolidone; copolymers of vinyl acetate with fumaric acid and its derivatives; and copolymers of (meth)acrylic acid and its derivatives with maleic acid and its derivatives.

The process of the present invention provides a means of preparing a mixture of a large number of copolymer compositions in a single operation by controlling the introduction of individual monomers or monomer types into the polymerizing medium during polymerization. As used herein, “monomer type” refers to those monomers that represent mixtures of individual closely related monomers, for example, LMA (mixture of lauryl and myristyl methacrylates), DPMA (a mixture of dodecyl, tridecyl, tetradecyl and pentadecyl methacrylates), SMA (mixture of hexadecyl and octadecyl methacrylates), CEMA (mixture of hexadecyl, octadecyl and eicosyl methacrylates). For the purposes of the present invention, each of these mixtures represents a single monomer or “monomer type” when describing monomer ratios and copolymer compositions. For example, a copolymer described as having a 70/30 LMA/CEMA composition is considered to contain 70% of a first monomer or monomer type (LMA) and 30% of a second monomer or monomer type (CEMA), although it is understood that the copolymer contains at least 5 different individual monomers (lauryl, myristyl, hexadecyl, octadecyl and eicosyl methacrylates).

As used herein, all percentages referred to will be expressed in weight percent (%), based on total weight of polymer or composition involved, unless specified otherwise.

Preferably, the second monomer composition is directly and gradually added from the feed vessel to the reaction vessel. The expression directly means that the second monomer composition is added to the reaction vessel without using a further mixing vessel.

Preferably, the first monomer composition comprises at least two monomers and/or the second monomer composition comprises at least two monomers. According to a preferred embodiment of the present invention, the first monomer composition comprises more different monomers than the second monomer composition; especially the first monomer composition may comprise at least one monomer, more preferably at least two monomers which are not present in the second monomer composition.

As used herein, the term “copolymer” or “copolymer material” refers to polymer compositions containing units of two or more monomers or monomer types. As used herein, the term “continuously variable-composition” refers to a copolymer composition where there is a distribution of single-composition copolymers within a copolymer material, that is, a copolymer material derived from a single polymerization process. The distribution of single-composition copolymers must be such that no more than 50%, and preferably no more than 20% of any single-composition copolymer is represented within the distribution range of single-composition copolymers in the copolymer material and at least four, preferably at least 5 and more preferably at least 10, different single-composition copolymers comprise the continuously-variable composition copolymer.

For the purposes of the present invention, a copolymer having a continuously-variable composition is defined as having a difference of at least 5%, preferably between 5% and 30% in at least one of the monomer or monomer type components of the single-composition copolymers of the copolymer composition range while satisfying the aforementioned requirement that no more than 50% of any single-composition copolymer is present in the copolymer material. A single-composition copolymer is defined as a copolymer differing from its nearest most similar copolymer by at least 1% in at least one monomeric component.

For example, in a copolymer material containing single-composition copolymers ranging from 70 Monomer A/30 Monomer B to 30 Monomer A/70 Monomer B (prepared by a polymerization using an initial 70 A/30 B monomer mix and gradual addition of Monomer B to the polymerizing monomer mixture until it is 30 A/70 B at the end of the monomer feed), the 61 A/39 B component is considered a single-composition copolymer and the 62 A/38 B component is considered a different single-composition copolymer. Using this example to further illustrate the concept of continuously variable-composition copolymers, the aforementioned copolymer composition would theoretically contain at least 40 different single-composition copolymers, each differing by 1% between 70 A/30 B and 30 A/70 B based on the theoretical formation of each single-composition copolymer during the polymerization, assuming the composition of the monomer feed being polymerized had been continuously adjusted throughout the polymerization process from one extreme of A/B composition to the other extreme of A/B composition. In this case, the copolymer material can be described as theoretically having about 2.5% each of 40 different single-composition copolymers, each differing by successive increments of 1% A and 1% B

As used herein, “theoretical formation” corresponds to the composition and amount (weight %) of a specific single-composition copolymer formed as a fraction of the entire range of copolymer compositions available. This is based on the assumption that the composition of the instantaneous polymer formed is equivalent to the unreacted monomer composition present in the reaction vessel at the time that the copolymer is formed. Thus, the initial single-composition copolymer prepared is equivalent to the first monomer composition described in step (a), which can be identified as A₁, B₁, C₁, . . . X₁. The unreacted monomer composition present in the reaction vessel than changes with the start of gradual addition of the second monomer composition as described in step (d) and with removal of available monomer from the reaction vessel as copolymerization occurs. As used herein, the term “gradual addition” refers to continuous or intermittent addition of monomer, monomer mixture or monomers over a period of time, dropwise or in a stream. As used herein, “intermittent” addition includes the brief interruption of the addition of monomer feed to the reactor or in-line mixing device so long as the interruption corresponds to a theoretical formation of no more than about 50% of a single-composition copolymer (based on monomer ratio in the reactor) within the range of copolymer compositions formed during the polymerization. Intermittent addition may also include multiple discrete additions of monomers or monomer mixtures, where the compositions of the monomer mixture at each discrete addition differs from at least one of the compositions of the other discrete additions by at least 5% in one or more components of the monomer mixture and the maximum contribution of any discrete monomer addition corresponds to less than 50% of a single-composition copolymer (based on monomer ratio in the reactor) within the range of copolymer compositions formed during the polymerization.

Preferably, the gradual addition of the one or more additional monomer mixtures in step (d) is conducted such that the addition begins before 50% of the first monomer mixture is converted to copolymer, and preferably before 25% is converted, and most preferably before 10% is converted. The one or more additional monomer mixtures is added at a rate such that at the end of the addition, at least 50% of the total monomers is converted to copolymers, and preferably at least 75% is converted, and most preferably at least 90% is converted.

As used herein, “under polymerization conditions” refers to conditions within the polymerization reactor sufficient to produce substantial incorporation of any monomers present into copolymer; that is, for example, the combination of temperature, type of free-radical initiator, and any optional promoter, provides an environment where the half-life of the initiator system is less than about 2 hours, preferably less than 1 hour, more preferably less than 10 minutes and most preferably less than about 5 minutes.

In step (c) the polymerization reaction in the reaction vessel is usually initiated by a free radical initiator. The initiation can be achieved, e.g. by raising the temperature if an initiator is present in the reaction vessel. Preferably, the initiation is achieved either through gradual addition of a free radical initiator to the reaction vessel or by inclusion of a free radical initiator into the second monomer composition after the desired reaction temperature has been achieved.

The process is directed towards producing a single continuously variable-composition copolymer in contrast to the preparation (in separate polymerizations) of different copolymers that are then combined to produce a physical mixture of single-composition copolymers (see U.S. Pat. No. 5,281,329 and European Patent Application EP 140,274). In this way, copolymers may be conveniently tailored to the specific end-use applications required of them without the need for multiple polymerization reactions and the isolation and storage of different copolymers to provide combination additive compositions.

There is no limitation on the extremes of the range of individual compositions within a given copolymer material prepared by the process of the present invention. For example, a copolymer material having an overall average composition of 50 A/50 B may be composed of individual single-composition copolymers ranging from 100 A/0 B to 0 A/100 B or only from 55 A/45 B to 45 A/55 B. In a similar fashion, a copolymer material having an overall average composition of 80 A/10 B/10 C (where C represents a third monomer) may be composed of individual single-composition copolymers ranging from, for example, 100 A/0 B/0 C to 60 A/20 B/20 C or only from 75 A/20 B/5 C to 85 A/0 B/15 C.

An advantage of the process of the present invention is the ability to easily vary the number of different single-composition copolymers formed within a single polymerization process. In addition, for a copolymer with the same range of individual single-composition copolymers as described above, the absolute number and distribution of the single-composition copolymers formed within a the polymerization process can be varied by varying parameters during the reaction such as reaction temperature, initiator feed rate, and/or the feed rate of the second and subsequent monomer mixtures. Using standard polymerization kinetics, one can estimate the instantaneous copolymer compositions as a function of polymer formation based on the first monomer composition and the second monomer composition using different feed rates for the second monomer composition. FIG. 1 provides such an estimate for the case where the starting monomer composition of 71.4 parts with A₁=30 wt. % and B₁=70 wt. % and the second monomer composition of 28.6 parts with A₂=100 wt. %. This is equivalent to an overall average composition of 50 A/50 B and overall compositions of between 30 A/70 B and 70 A/30 B. As illustrated in FIG. 2, the instantaneous polymer composition produced throughout the copolymerization process varies as a function of the feed rate of the second monomer to the polymerization reactor. Similar variations are observed by varying the rate and/or amount of initiator addition and by varying the polymerization temperature.

The process of the invention may have multiple monomer feeds which can have different feed rates in order to control the incorporation of monomers of significantly different reactivities, such as (meth)acrylic esters and styrene derivatives. If desired, control of copolymer composition can be derived from application of the well-known copolymer equation based on the use of monomer reactivity ratios (Textbook of Polymer Science by F. W. Billmeyer, Jr., pp 310-325 (1966)). U.S. Pat. No. 4,048,413 discloses the use of monomer reactivity ratios and addition of increasing amounts of the more reactive monomer component of the desired copolymer during the polymerization to achieve a constant-composition copolymer. In contrast to the teachings and objects of U.S. Pat. No. 4,048,413, the process of the present invention is directed to providing continuously-changing composition or continuously-variable composition copolymers during a single polymerization process.

Preferably, the process of the present invention is practiced to prepare copolymer materials having a large number of individual single-composition copolymers, the range being represented by extremes in copolymer composition established by the monomer feed conditions and monomer ratios. Variations in the composition of the monomer feeds during the polymerization are not limited to being uniformly increased or decreased from an initial composition proceeding towards a specified final composition. All that is necessary is that the overall requirements defining the preparation of a continuously variable-composition copolymer be satisfied:

(1) no single-composition copolymer composition may represent more than 50% of the copolymer material within the range of single-composition copolymers defining the copolymer material,

(2) the copolymer material must contain individual single-composition copolymers having a difference of at least 5% between at least one of the monomer or monomer type components of the single-composition copolymers,

(3) the copolymer material must contain at least four different single-composition copolymers, and

(4) a single-composition copolymer is defined as having a composition differing from its nearest most similar composition by at least 1% in at least one monomeric component of the composition.

Lubricating oil additives, for example pour point depressants, thickeners, viscosity index (VI) improvers and dispersants, may be prepared using the process of the present invention.

Preferred polymers useful as VI improvers and/or pour point depressants comprise units derived from alkyl esters having at least one ethylenically unsaturated group. These polymers are well known in the art. Preferred polymers are obtainable by polymerizing, in particular, (meth)acrylates, maleates and fumarates. The term (meth)acrylates includes methacrylates and acrylates as well as mixtures of the two. These monomers are well known in the art. The alkyl residue can be linear, cyclic or branched.

Compositions to obtain preferred copolymers comprising units derived from alkyl esters contain 0 to 100 wt %, preferably 0 to 90 wt %, especially 0 to 80 wt %, more preferably 0 to 30 wt %, more preferably 0 to 20 wt % based on the total weight of the monomer mixture of one or more ethylenically unsaturated ester compounds of formula (I)

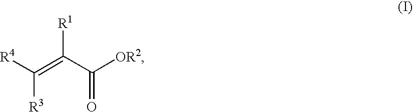

wherein R¹ is hydrogen or methyl, R² means a linear or branched alkyl residue with 1-6 carbon atoms, R³ and R⁴ independently represent hydrogen or a group of the formula—COOR′, where R′ means hydrogen or a alkyl group with 1-6 carbon atoms. In the preferred embodiment, R³ and R⁴ are hydrogen. The amount of one or more ethylenically unsaturated ester compounds of formula (I) includes all values and subvalues therebetween, especially including 10, 20, 30, 40, 50, 60, 70, 80 and 90 wt %.

Examples of monomers according to formula (I) are mentioned above.

Furthermore, the monomer compositions to obtain preferred copolymers comprising units derived from alkyl esters contain 0-100 wt %, preferably 10-99 wt %, especially 20-95 wt % and more preferably 30 to 85 wt % based on the total weight of the monomer mixture of one or more ethylenically unsaturated ester compounds of formula (II)

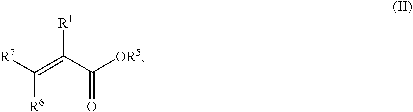

wherein R¹ is hydrogen or methyl, R⁵ means a linear or branched alkyl residue with 7-40, especially 10 to 30 and preferably 12 to 24 carbon atoms, R⁶ and R⁷ are independently hydrogen or a group of the formula —COOR″, wherein R″ means hydrogen or an alkyl group with 7 to 40, especially 10 to 30 and preferably 12 to 24 carbon atoms. The amount of one or more ethylenically unsaturated ester compounds of formula (II) includes all values and subvalues therebetween, especially including 10, 20, 30, 40, 50, 60, 70, 80 and 90 wt %.

Of the ethylenically unsaturated ester compounds, the (meth)acrylates are particularly preferred over the maleates and furmarates, i.e., R³, R⁴, R⁶, R⁷ of formulas (I) and (II) represent hydrogen in particularly preferred embodiments.

In a particular aspect of the present invention, preference is given to using mixtures of ethylenically unsaturated ester compounds of formula (II), and the mixtures have at least one (meth)acrylate having from 7 to 15 carbon atoms in the alcohol radical and at least one (meth)acrylate having from 16 to 30 carbon atoms in the alcohol radical. The fraction of the (meth)acrylates having from 7 to 15 carbon atoms in the alcohol radical is preferably in the range from 20 to 95% by weight, based on the weight of the monomer composition for the preparation of polymers. The fraction of the (meth)acrylates having from 16 to 30 carbon atoms in the alcohol radical is preferably in the range from 0.5 to 60% by weight based on the weight of the monomer composition for the preparation of the polymers comprising units derived from alkyl esters. The weight ratio of the (meth)acrylate having from 7 to 15 carbon atoms in the alcohol radical and the (meth)acrylate having from 16 to 30 carbon atoms in the alcohol radical is preferably in the range of 10:1 to 1:10, more preferably in the range of 5:1 to 1.5:1.

Examples of monomers according to formula (II) are mentioned above.

Furthermore, the mixtures may comprise ethylenically unsaturated monomers that can copolymerize with the ethylenically unsaturated ester compounds of formula (I) and/or (II). Examples of these monomers are mentioned above.

In these cases, continuously variable-composition copolymers comprising single-composition copolymers having monomeric units selected from two or more of methyl methacrylate, butyl methacrylate, isodecyl methacrylate, lauryl-myristyl methacrylate, dodecyl-pentadecyl methacrylate, cetyl-eicosyl methacrylate and cetyl-stearyl methacrylate are preferred. Preferably the continuously variable-composition copolymers used as lubricating oil additives have an overall average composition of 40-90% A and 10-60% B and preferably 50-70% A and 30-50% B, where A represents monomeric units selected from one or more of isodecyl methacrylate (IDMA), lauryl-myristyl methacrylate (LMA) and dodecyl-pentadecyl methacrylate (DPMA) and B represents monomeric units selected from one or more of cetyl-eicosyl methacrylate (CEMA) and cetyl-stearyl methacrylate (SMA). Preferably the monomeric unit composition range of single-composition copolymers in continuously variable-composition copolymers used as lubricating oil additives is 5 to 100%, preferably from 10 to 80%, more preferably from 20 to 50% and most preferably from 30 to 40% for at least one of the monomeric unit components, A or B; for example, using the same definitions for A and B monomeric units as above, the continuously variable-composition copolymers may contain 10 LMA/90 SMA copolymer up to 90 LMA/10 SMA copolymer (range of 80%) or 25 LMA/75 SMA copolymer up to 75 LMA/25 SMA copolymer (range of 50%) or 30 LMA/70 SMA copolymer up to 70 LMA/30 SMA copolymer (range of 40%), with each continuously-variable composition having an overall average composition of 50 LMA/50 SMA. The monomeric unit composition range need not be symmetrical around the overall average composition of the continuously-variable composition copolymer.

A preferred application of this technique is the preparation of VI improver additives that provide improved VI and low temperature performance by allowing greater amounts of low-solubility monomers, such as methyl methacrylate, to be used in the polymer additive. Another preferred application of this technique is the preparation of polymeric pour point depressant additives that provide improved low temperature fluidity when used in a variety of petroleum base oils. In general, low temperature is meant to refer to temperatures below about −20° C. (corresponds to −4 F); fluidity at temperatures below about −25° C. (corresponds to −13 F) is of particular interest in the use of pour point depressant additives.

When the process of the present invention is used to prepare lubricating oil additives, typical maximum [Aᵢ-A_{T}] or [Bᵢ-B_{T}] absolute values used during the polymerization are from 5 to 100%, preferably from 10 to 80% and more preferably from 20 to 50%, wherein Aᵢ, A_{T}, Bᵢ and B_{T} represent instantaneous weight percents of any two A and B monomers added to the reactor initially (Aᵢ and Bᵢ) and at some time later in the polymerization (A_{T} and B_{T}). For example, pour point depressant additives based on variable-composition copolymers prepared where the [Aᵢ-A_{T}] or [Bᵢ-B_{T}] values are from 30 to 40% are preferred for use in a wide range of base oils. The typical maximum [Aᵢ-A_{T}] or [Bᵢ-B_{T}] absolute values used during the polymerization includes all values and subvalues therebetween, especially including 10, 20, 30, 40, 50, 60, 70, 80 and 90 wt %.

Copolymers prepared by the process of the present invention offer wider applicability in treatment of base oils from different sources when compared to single-composition polymer additives or combinations of separately prepared single-composition polymer additives. In some cases the continuously-variable composition copolymers of the present invention equal or exceed the low temperature performance of comparable single-composition polymer additives or mixtures thereof; in all cases the continuously-variable composition copolymers offer the advantage of broader applicability to different base oils without requiring the separate preparation and then combination of different single-composition polymers to achieve satisfactory performance in a variety of base oils.

Preferably, the process of this invention is used to produce continuously-variable composition copolymers by semi-batch methods. As used herein, semi-batch refers to processes in which reactants are added to a polymerization reactor, one or more of which may be added over the course of the reaction, and the finished copolymer is removed as the final product after polymerization has been completed. A batch polymerization refers to processes in which the reactants are all added to the reactor initially and the finished polymer is removed as the final product after polymerization has been completed. Among the reactor types useful in the practice of the present invention are, for example, pipe (plug-flow), recycle-loop and continuous-feed-stirred-tank (CFSTR) type reactors.

According to a preferred embodiment of the present process, the reaction mixture is intensively stirred during the addition of the second monomer composition to the reaction vessel. Preferably, the stirring rate in the reaction vessel is in the range from 10 to 1000 rpm, more preferably 50 to 500 rpm. Useful devices to achieve a good mixing of the reaction mixture are well known in the art. E.g. these devices include pitched blade turbines.

Preferably, the process of the present invention can be conducted as a combination co-feed-heel process. A heel process is one where some portion of one or more of the reactants or diluents is present in the polymerization reactor and the remaining reactants and diluents are then added to the reactor at some later point. A combination of a heel and a co-feed process is one where a portion of one or more of the reactants or diluents is present in the polymerization reactor, and the remainder of the one or more reactants or diluents is metered (including variation of individual monomer feed rates), or fed, into the reactor over a period of time.

According to the process of the present invention, the monomers provided in the reaction vessel by the first monomer composition composes at least 50% by weight of all the monomers used to prepare said copolymer, preferably at least 60% by weight of all the monomers used to prepare said copolymer and more preferably at least 70% by weight of all the monomers used to prepare said copolymer. Preferably, the weight ratio of said first monomer composition to said second monomer composition is within the range of 20:1 to 1:1, most preferably 12:1 to 1:1.

Two or more different monomer feeds can be added to the reaction vessel comprising the first monomer mixture. However, additional monomer feeds impart higher efforts to control the copolymer composition and the polymerization process. Additionally, a higher investment is needed in order to build a plant being able to perform such process. Consequently, the reaction system preferably comprises just one feed vessel from which the second monomer composition is added to the reaction vessel. Furthermore, the sum of the monomers of said first monomer composition and said second monomer composition preferably composes at least 80%, more preferably at least 95% by weight of all the monomers used to prepare said copolymer. According to a preferred aspect of the present invention just one second monomer composition is added to the reaction vessel.

The addition rate of the second monomer composition can be either held constant or can be reduced or increased during the addition to the reaction vessel. In the preferred embodiment, the addition rate of the second monomer composition is held constant during the addition to the reaction vessel.

According to a preferred embodiment, the addition rate of the second monomer composition to the reaction vessel is adapted according to the conversion rate of the monomer composition being present in the reaction vessel. E.g. the conversation rate can be controlled by the initiator feed and/or by the reaction temperature. Preferably, the addition rate corresponds approximately to the conversion rate. For example, the ratio of the addition rate and the conversion rate can be within the range of 3:1 to 1:3, preferably 2:1 to 1:2.

In the context of the present invention, the conversion rate (or reaction rate is the rate at which a monomer is converted to polymer.

The process of the present invention is applicable to preparing copolymers by bulk or solution polymerization techniques.

The process of the present invention is particularly applicable to preparing polymers by solution polymerization. Preferably, the process of the present invention is applied to solution (solvent) polymerizations by mixing the selected monomers in the presence of a polymerization initiator, a diluent and optionally a chain transfer agent.

Generally, the temperature of the polymerization may be up to the boiling point of the system, for example, from about 60 to 150° C., preferably from 85 to 130° C. and more preferably from 110 to 120° C., although the polymerization can be conducted under pressure if higher temperatures are used. The reaction temperature is either held constant or reduced at the end of the monomer feed. According to a preferred embodiment, the reaction temperature can be lowered by 0° C. to 20° C., more preferably 5° C. to 15° C. after completion of the addition of the second monomer composition. The polymerization (including monomer feed and hold times) is run generally for about 4 to 10 hours, preferably from 2 to 3 hours, or until the desired degree of polymerization has been reached, for example until at least 90%, preferably at least 95% and more preferably at least 97% of the copolymerizable monomers have been converted to copolymers. As is recognized by those skilled in the art, the time and temperature of the reaction are dependent on the choice of initiator and target molecular weight and can be varied accordingly.

When the process of the present invention is used for solvent (non-aqeuous) polymerizations, initiators suitable for use are any of the well known free-radical-producing compounds such as peroxy, hydroperoxy and azo initiators, including, for example, acetyl peroxide, benzoyl peroxide, lauroyl peroxide, tert-butyl peroxyisobutyrate, caproyl peroxide, cumene hydroperoxide, 1,1-di(tert-butylperoxy)-3,3,5-trimethylcyclohexane, azobisisobutyronitrile and tert-butyl peroctoate (also known as tert-butylperoxy-2-ethylhexanoate). The total amount of initiator is typically between 0.025 and 1%, preferably from 0.05 to 0.5%, more preferably from 0.1 to 0.4% and most preferably from 0.2 to 0.3%, by weight based on the total weight of the monomers.

In the preferred embodiment of this invention, the initiator is added as a separate feed throughout the course of the polymerization reaction. According to that specific embodiment, the addition of the initiator to the reaction vessel can be performed in two or more steps. Preferably, the addition rate of the initiator can be increased with the subsequent steps. The amount of initiator added to the polymerization reaction before addition of the second monomer composition is preferably in the range of 0.2 to 10% by weight, more preferably 0.5 to 5% based on the total amount of initiator. The amount of initiator added concurrently with the addition of the second and subsequent monomers is preferably in the range of 20% to 99.8% based on the total amount of initiator. More preferably, the amount added concurrently with the addition of the second and subsequent monomers is in the range of 20% to 50%.

In the first and/or in the second and subsequent steps, the polymerization initiator can be added gradually, preferably with a constant application rate whereby the average application rate of the second and subsequent steps is higher than the average application rate of the first or previous step. The ratio of the average application rate of the second step to the average application rate of the first step is preferably more than 1.2:1, in particular in the range of 1.2:1 to 10:1, more particular more than 1.5:1, most particular more than 2:1, especially 3:1.

Initiator addition is continued after completion of monomer feeds, with the amount of initiator added in the range of 20% to 80%, more preferably in the range of 40 to 70%. The amount of initiator includes all values and subvalues therebetween, especially including 30, 40, 50, 60 and 70 wt %.

Alternatively, the initiator can be added as a single addition at the completion of monomer feeds rather then added as a feed.

According to a preferred embodiment, initiator can be added to the reaction vessel as a separate continuous feed stream that starts when the reaction vessel containing the first monomer composition reaches the desired reaction temperature.

The addition of the polymerization initiator can be carried out with or without a solvent. The addition of the polymerization initiator in solution is preferred, in particular in form of a 3 to 25 wt % solution in at least one mineral oil.

The residual amount of polymerization initiator can be estimated in a known manner or on basis of known values as for example the decomposition rate, the temperature profile during the polymerization and the addition profile.

For the addition with constant speed at a constant temperature the following equation is approximately valid:

I_{SS}/I_{Σ}=1/(k_{d}t_{Σ})

wherein the ratio I_{SS}/I_{Σ} refers to the part of polymerization initiator not yet consumed in reference to the total amount of the polymerization initiator added in the first step and wherein k_{d} is the decomposition constant of the polymerization initiator and wherein t_{Σ} is the addition period.

In the preferred embodiment, the addition of the polymerization initiator can be performed in three steps, wherein in the third step more initiator is added than in the second step and more initiator is added in the second step than in the first step. In the preferred embodiment, the third addition step is started at the conclusion of the addition of the second monomer composition.

Alternatively, the addition of the initiator can be performed batchwise. Furthermore, the first addition of the initiator may be performed as a batch addition to the first monomer composition in order to establish polymerization conditions. After a short time the second monomer composition is gradually added to the reaction vessel, e.g. after 0 to 15 minutes, preferably 5 to 10 minutes. The second monomer composition may comprise polymerization initiator and, consequently, the addition of the polymerization initiator in the second step involves the addition of the second monomer composition. Furthermore, the second addition of the polymerization initiator could be performed as a batch during the addition of the second monomer composition. E.g. the second step addition of initiator can be performed after 10% by weight, preferably after 30% by weight more preferably after 40% by weight of the second monomer composition has been added to the polymerization reactor. As mentioned above, additional initiator may be added in a third step. The third step addition can be performed gradually or as a batch. E.g. the third step addition of initiator can be performed after 70% by weight, preferably after 90% by weight more preferably after 100% by weight of the second monomer composition has been added to the polymerization reactor.

According to a preferred embodiment of the present invention, polymerization initiator can be added to the reaction vessel after the addition of the second monomer feed has been completed. Preferably, the addition of the initiator can be completed within a period of time of about 120 minutes, more preferably 60 minutes after the second monomer addition has been completed and most preferably 30 minutes after the second monomer addition has been completed. The addition of the initiator after the end of the addition of the second monomer composition can be performed as a batch or continuously.

In addition to the initiator, one or more promoters may also be used. Suitable promoters include, for example, quaternary ammonium salts such as benzyl(hydrogenated-tallow)-dimethylammonium chloride and amines. Preferably the promoters are soluble in hydrocarbons. When used, these promoters are present at levels from about 1% to 50%, preferably from about 5% to 25%, based on total weight of initiator.

Chain transfer agents may also be added to the polymerization reaction to control the molecular weight of the polymer. The preferred chain transfer agents are alkyl mercaptans such as lauryl mercaptan (also known as dodecyl mercaptan, DDM), and the concentration of chain transfer agent used is from zero to about 2%, preferably from zero to 1%, by weight.

If used, the chain transfer agent can be added during the polymerization reaction and/or before the start of the polymerization reaction. Preferably, the first monomer composition comprises at least 0.05% by weight, more preferably at least 0.1% by weight of the chain transfer agent and/or the second monomer composition comprises at least 0.05% by weight, more preferably at least 0.1% by weight of the chain transfer agent. According to a preferred embodiment, the first monomer composition and the second comprises at least one chain transfer agent.

When the polymerization is conducted as a solution polymerization using a solvent other than water, the reaction may be conducted at up to about 100% (where the polymer formed acts as its own solvent) or up to about 70%, preferably from 80 to 95%, by weight of polymerizable monomers based on the total reaction mixture. The solvents, if used, can be introduced into the reaction vessel as a heel charge, or can be fed into the reactor either as a separate feed stream or as a diluent for one of the other components being fed into the reactor.

Diluents may be added to the monomer mix or they may be added to the reactor along with the monomer feed. Diluents may also be used to provide a solvent heel, preferably non-reactive, for the polymerization. Preferably, materials selected as diluents should be substantially non-reactive towards the initiators or intermediates in the polymerization to minimize side reactions such as chain transfer and the like. The diluent may also be any polymeric material which acts as a solvent and is otherwise compatible with the monomers and polymerization ingredients being used.

Among the diluents suitable for use in the process of the present invention for non-aqueous solution polymerizations are aromatic hydrocarbons (such as benzene, toluene, xylene and aromatic naphthas), chlorinated hydrocarbons (such as ethylene dichloride, chlorobenzene and dichlorobenzene), esters (such as ethyl propionate or butyl acetate), (C6-C20)aliphatic hydrocarbons (such as cyclohexane, heptane and octane), petroleum base oils (such as paraffinic and naphthenic oils) or synthetic base oils (such as olefin copolymer (OCP) lubricating oils, for example poly(ethylene-propylene) or poly(isobutylene)). When the concentrate is directly blended into a lubricating base oil, the more preferred diluent is any mineral oil, such as 100 to 150 neutral oil (100 N or 150 N oil), which is compatible with the final lubricating base oil.

In the preparation of lubricating oil additive polymers, the resultant polymer solution, after the polymerization, generally has a polymer content of about 50 to 95% by weight. The polymer content includes all values and subvalues therebetween, especially including 60, 65, 70, 75, 80, 85 and 90 wt %.

The polymer can be isolated and used directly in lubricating oil formulations or the polymer-diluent solution can be used in a concentrate form. When used in the concentrate form the polymer concentration can be adjusted to any desirable level with additional diluent. The preferred concentration of polymer in the concentrate is from 30 to 70% by weight. The concentration of polymer includes all values and subvalues therebetween, especially including 35, 40, 45, 50, 55, 60 and 65 wt %.

When a polymer prepared by the process of the present invention is added to base oil fluids, whether it is added as pure polymer or as concentrate, the final concentration of the polymer in the formulated fluid is typically from 0.05 to 20%, preferably from 0.2 to 15% and more preferably from 2 to 10%, depending on the specific use application requirements. For example, when the continuously variable-composition copolymers are used to maintain low temperature fluidity in lubricating oils, for example as pour point depressants, the final concentration of the continuously variable-composition copolymer in the formulated fluid is typically from 0.05 to 3%, preferably from 0.1 to 2% and more preferably from 0.1 to 1%; when the continuously variable-composition copolymers are used as VI improvers in lubricating oils, the final concentration in the formulated fluid is typically from 1 to 6% and preferably from 2 to 5%; and when the continuously variable-composition copolymers are used as hydraulic fluid additives, the final concentration in the formulated fluid is typically from 5 to 15% and preferably from 3 to 10%.

The continuously variable composition copolymer is soluble in lubricating oil. Lubricating oils are well known in the art. Usually, these oils comprise petroleum base oils (such as paraffinic and naphthenic oils) or synthetic base oils as mentioned above. Lubricating oils are also used as hydraulic fluids. As used herein the term “soluble” means that one fluid phase is formed with the lubricating oil after addition of an effective amount of the present copolymers as mentioned above.

Weight-average molecular weights of copolymers useful as lubricating oil additives may be from 10,000 to 1,000,000. As the weight-average molecular weights of the polymers increase, they become more efficient thickeners; however, they can undergo mechanical degradation in particular applications and for this reason, polymer additives with Mw above about 500,000 are not suitable because they tend to undergo “thinning” due to molecular weight degradation resulting in loss of effectiveness as thickeners at the higher use temperatures (for example, at 100° C.). Thus, the desired Mw is ultimately governed by thickening efficiency, cost and the type of application. In general, polymeric pour point depressant additives of the present invention have Mw from about 30,000 to about 700,000 (as determined by gel permeation chromatography (GPC), using poly(alkylmethacrylate) standards); preferably, Mw is in the range from 60,000 to 350,000 in order to satisfy the particular use as pour point depressants. Weight-average molecular weights from 70,000 up to 300,000 are preferred.

The polydispersity index of the polymers prepared by the process of the present invention may be from 1 to about 15, preferably from 1.5 to about 4. The polydispersity index (Mw/Mn, as measured by GPC, where Mn is number-average molecular weight) is a measure of the narrowness of the molecular weight distribution with higher values representing increasingly broader distributions. It is preferred that the molecular weight distribution be as narrow as possible for polymers used as VI improvers in crankcase and hydraulic fluid applications, but this is generally limited by the method of manufacture. Some approaches to providing narrow molecular weight distributions (low Mw Mn) include, for example, one or more of the following methods: continuous-feed-stirred-tank-reactor (CFSTR); low-conversion polymerization; control of temperature or initiator/monomer ratio (such as disclosed in EP 561078 to achieve a constant degree of polymerization) during polymerization; and mechanical shearing, for example homogenization, of the polymer.

Those skilled in the art will recognize that the molecular weights set forth throughout this specification are relative to the methods by which they are determined. For example, molecular weights determined by GPC and molecular weights calculated by other methods, may have different values. It is not molecular weight per se but the handling characteristics and performance of a polymeric additive (shear stability and thickening power under use conditions) that is important. Generally, shear stability is inversely proportional to molecular weight. A VI improving additive with good shear stability (low SSI value, see below) is typically used at higher initial concentrations relative to another additive having reduced shear stability (high SSI value) to obtain the same target thickening effect in a treated fluid at high temperatures; the additive having good shear stability may, however, produce unacceptable thickening at low temperatures due to the higher use concentrations.

Therefore, polymer composition, molecular weight and shear stability of pour point depressant and VI improving additives used to treat different fluids must be selected to achieve a balance of properties in order to satisfy both high and low temperatures performance requirements.

The shear stability index (SSI) can be directly correlated to polymer molecular weight and is a measure of the percent loss in polymeric additive-contributed viscosity due to mechanical shearing and can be determined, for example, by measuring sonic shear stability for a given amount of time according to ASTM D-2603-91 (published by the American Society for Testing and Materials). Depending on the end use application of the lubricating oil, the viscosity is measured before and after shearing for specified time periods to determine the SSI value. In general, higher molecular weight polymers undergo the greatest relative reduction in molecular weight when subjected to high shear conditions and, therefore, these higher molecular weight polymers also exhibit the largest SSI values. Therefore, when comparing the shear stabilities of polymers, good shear stability is associated with the lower SSI values and reduced shear stability with the higher SSI values.

The SSI range for alkyl (meth)acrylate polymers useful as lubricating oil additives (for example: VI improvers, thickeners, pour point depressants, dispersants) prepared by the process of this invention is from about zero to about 60%, preferably from 1 to 40% and more preferably from 5 to 30% and will vary depending upon the end use application; values for SSI are usually expressed as whole numbers, although the value is a percentage. The desired SSI for a polymer can be achieved by either varying synthesis reaction conditions or by mechanically shearing the known molecular weight product polymer to the desired value.

Representative of the types of shear stability that are observed for conventional lubricating oil additives of different Mw are the following: conventional poly(methacrylate) additives having Mw of 130,000, 490,000 and 880,000, respectively, would have SSI values (210 F) of 0, 5 and 20%, respectively, based on a 2000 mile road shear test for engine oil formulations; based on a 20,000 mile high speed road test for automatic transmission fluid (ATF) formulations, the SSI values (210 F) were 0, 35 and 50%, respectively; and based on a 100 hour ASTM D-2882-90 pump test for hydraulic fluids, the SSI values (100 F) were 18, 68, and 76%, respectively (Effect of Viscosity Index Improver on In-Service Viscosity of Hydraulic Fluids, R. J. Kopko and R. L. Stambaugh, Fuel and Lubricants Meeting, Houston, Tex., Jun. 3-5, 1975, Society of Automotive Engineers).

Pumpability of an oil at low temperatures, as measured by the mini-rotary viscometer (MRV), relates to viscosity under low shear conditions at engine startup. Since the MRV test is a measure of pumpability, the engine oil must be fluid enough so that it can be pumped to all engine parts after engine startup to provide adequate lubrication. ASTM D-4684-89 deals with viscosity measurement in the temperature range of −10 to −30° C. and describes the TP-1 MRV test. SAE J300 Engine Oil Viscosity Classification (December 1995) allows a maximum of 30 pascal*seconds (pa*sec) or 300 poise at −30° C. for SAE 5W-30 oil using the ASTM D-4684-89 test procedure. Another aspect of low temperature performance measured by the TP-1 MRV test is yield stress (recorded in pascals); the target value for yield stress is “zero” pascals, although any value less than 35 pascals (limit of sensitivity of equipment) is recorded as “zero” yield stress. Yield stress values greater than 35 pascals signify increasing degrees of less desirable performance.

Having generally described this invention, a further understanding can be obtained by reference to certain specific examples which are provided herein for purposes of illustration only, and are not intended to be limiting unless otherwise specified.

### EXAMPLES

### Measurement of the Weight Average Molecular Weight of the Polymers by Gel Permeation Chromatography (GPC)

### GPC (Gel Permeation Chromatorgaphy) Conditions

GPC system: Waters 150 C (by Waters Corporation)
(includes auto sampler, pump, column oven, refractive index (R1) detector)
Solvent: THF (tetrahydrofuran) (Fischer Certified), inhibited with 100 ppm BHT, (run isocratic, helium spurge)

### Columns: Two Styragel HR5E 7.8×300 mm (Part # WAT044228)

Column temperature: 40° C.
Flow Rate: 1.0 ml/min.

### Detection: RI at 40° C.

Run time: 30 minutes
Injection volume: 100 micro liters
Sample concentration: 0.25 wt % in THF (for a typical product, less for a narrow molecular weight distribution sample like a PMMA standard)
Calibration: PMMA (poly methyl methacrylate)
The PMMA standards are manufactured by Polymer Standard Service (PSS) and have a typical molecular weight distribution (Mw/Mn) of about 1.05. They have a concentration at about 0.05 wt. % in THF.

### Example 1

A reaction mixture was prepared by blending 465 parts LMA, 438 parts SMA, and 3.3 parts DDM. The reaction mixture was heated to 120° C. and a free radical initiator solution of 3.8 parts t-butyl peroctoate (50% in odorless mineral spirits) and 19.3 parts 100N polymerization oil was added over 165 minutes. Ten percent of this free radical initiator solution was added in the first hour, followed by 20% in the second hour, and the remainder in the final 0.75 hours. The monomer addition mixture consisting of 70 parts LMA and 0.26 parts DDM was added at a constant rate over 1.92 hours, with the addition starting 5 minutes after the start of the initiator solution addition. The reaction temperature was decreased to 105° C. at the end of the addition of the monomer mixture. The reaction mixture was held one hour after completion of the initiator addition, than diluted with 1467.5 parts of 100N oil. The composition of materials formed starts at about 52% LMA, 48% SMA and ends at about 59% LMA, 41% SMA. The product before the dilution step contained 94.1% polymer solids, which represented a 99.0% conversion of monomers to polymer. The polymer produced had a weight average molecular weight of about 124,000 (as determined by gel permeation chromatography (GPC), using poly(alkylmethacrylate) standards) and a polydispersity of about 3.35.

The obtained continuously variable composition copolymers were evaluated by using different base oils. The results achieved were shown in Table 1.

### Comparative Example 1

Monomer mixture “A” was prepared by blending 535 parts LMA, 4.22 parts t-butyl peroctoate (50% in odorless mineral spirits), and 0.95 parts n-DDM. Monomer mixture “B” was prepared by blending 438 parts SMA, 3.38 parts t-butyl peroctoate (50% in odorless mineral spirits), and 0.76 parts n-DDM. 143.4 parts of 100N polymerization oil and 0.95 parts t-butyl peroctoate (50% in odorless mineral spirits) was added to a reaction vessel and heated to 120° C. Monomer mixture “A” and monomer mixture “B” was fed to the reactor over 90 minutes at rates designed to provide a starting monomer ratio of 52 percent LMA and an ending monomer ratio of 59 percent LMA. At the end of the monomer feed, the temperature was decreased to 110° C. and 2.91 parts t-butyl peroctoate (50% in odorless mineral spirits) was fed at a constant rate over 30 minutes. The reaction mixture was held 30 minutes after completion of the initiator addition, than diluted with 1336 parts of 100N oil.

The obtained continuously variable composition copolymers were evaluated by using different base oils. The results achieved were shown in Table 1 and Table 2.

TABLE 1
Application Results

| | Formulation 1 | | Formulation 2 | | Formulation 3 | | Formulation 4 | |
|---|---|---|---|---|---|---|---|---|
| PPD | Single | | Single | | Single | | Single | |
| Process | Feed | Control | Feed | Control | Feed | Control | Feed | Control |
| SAE | 5W-30 | 5W-30 | 5W-30 | 5W-30 | 5W-30 | 5W-30 | 10W-? | 10w-? |
| GRADE | | | | | | | | |
| TP1 @ | −35 | −35 | −35 | −35 | −35 | −35 | −30 | −30 |
| Ys | 0 | 0 | 0 | 0 | 0 | 0 | 0 | 0 |
| Viscosity | 248 | 234 | 156 | 161 | 158 | 159 | 193 | 170 |
| TP1 @ | −40 | −40 | −40 | −40 | −40 | −40 | −35 | −35 |
| Ys | 0 | 0 | 0 | 0 | 0 | 0 | 0 | 0 |
| Viscosity | 860 | 798 | 402 | 452 | 449 | 451 | 525 | 447 |

### Example 2

A reaction mixture was prepared by blending 530 parts LMA, 582 parts CEMA, and 4.1 parts n-DDM. The reaction mixture was heated to 120° C. and a free radical initiator solution of 5.2 parts t-butyl peroctoate (50% in odorless mineral spirits) and 30.3 parts 100N polymerization oil was added over 100 minutes. Fifteen percent of this free radical initiator solution was added in the first 30 minutes, followed by 25% in the next 40 minutes, and the remainder in the final 30 minutes. The monomer addition mixture consisting of 216 parts LMA and 0.8 parts n-DDM was added at a constant rate over 65 minutes, with the addition starting 5 minutes after the start of the initiator solution addition. The reaction temperature was decreased to 105° C. at the end of the addition of the monomer mixture. The reaction mixture was held one hour after completion of the initiator addition, than diluted with 2006.2 parts of 100N oil. The composition of materials formed starts at about 48% LMA, 52% CEMA and ends at about 65% LMA, 15% CEMA. The product before the dilution step contained 94.6% polymer solids, which represented a 99.6% conversion of monomers to polymer. The polymer produced had a weight average molecular weight of about 133,000 (as determined by gel permeation chromatography (GPC), using poly(alkylmethacrylate) standards) and a polydispersity of about 3.0.

### Example 3

A reaction mixture was prepared by blending 544.8 parts LMA, 230.3 parts MMA, 107.3 parts 100N polymerization oil and 5.14 parts n-DDM. The reaction mixture was heated to 110° C. and a free radical initiator solution of 4.6 parts t-butyl peroctoate (50% in odorless mineral spirits) and 69 parts 100N polymerization oil was added over 165 minutes. Ten percent of this free radical initiator solution was added in the first hour, followed by 20% in the second hour, and the remainder in the final 45 minutes. The monomer addition mixture consisting of 389.2 parts LMA and 2.6 parts n-DDM was added at a constant rate over 115 minutes, with the addition starting 5 minutes after the start of the initiator solution addition. The reaction temperature was decreased to 100° C. at the end of the addition of the monomer mixture. The reaction mixture was held 30 minutes after completion of the initiator addition, than diluted with 245.6 parts of 100N oil. The composition of materials formed starts at about 70% LMA, 30% MMA and ends at about 90% LMA, 10% MMA. A 99.6% conversion of monomers to polymer had been achieved.

### Example 4

A reaction mixture was prepared by blending 522 parts LMA, 410 parts SMA, and 3.4 parts DDM. The reaction mixture was heated to 120° C. and a free radical initiator solution of 5.20 parts t-butyl peroctoate (50% in odorless mineral spirits) and 27.61 parts 100N polymerization oil was added over 120 minutes. Fifteen percent of this free radical initiator solution was added in the first hour, followed by 25% in the next half hour, and the remainder in the final half hour. The monomer addition mixture consisting of 270 parts LMA, 129 parts of SMA and 1.46 parts DDM was added at a constant rate over 1.5 hours, with the addition starting at the start of the initiator solution addition. The reaction temperature was decreased to 105° C. at the end of the addition of the monomer mixture. The reaction mixture was held one hour after completion of the initiator addition, than diluted with 2052.6 parts of 100N oil. The composition of materials formed starts at about 56.5% LMA, 43.5% SMA and ends at about 63.5% LMA, 36.5% SMA. The product before the dilution step contained 94.1% polymer solids, which represented a 99.0% conversion of monomers to polymer. The polymer produced had a weight average molecular weight of about 101,000 (as determined by gel permeation chromatography (GPC), using poly(alkylmethacrylate) standards) and a polydispersity of about 2.27.

The obtained continuously variable composition copolymers were evaluated by using different base oils. The results achieved were shown in Table 2.

TABLE 2
Application Results

| | Formulation 1 | | Formulation 2 | | Formulation 3 | |
|---|---|---|---|---|---|---|
| PPD | Single | | Single | | Single | |
| Process | Feed | Control | Feed | Control | Feed | Control |
| SAE GRADE | 5W-30 | 5W-30 | 10W-40 | 10W-40 | 5W-30 | 5W-30 |
| TP1 @ | −35 | −35 | −30 | −30 | −35 | −35 |
| Ys | 0 | 0 | 0 | 0 | 0 | 0 |
| Viscosity | 19,400 | 18,400 | 29,800 | 30,500 | 19,100 | 18,300 |
| ASTM D5133 | | | | | | |
| Gel Index | 6.0 | 6.1 | 4.7 | 4.3 | 7.7 | 9.1 |
| Viscosity @ −30° C. | 20,456 | 21,008 | 31,242 | 35,248 | 19,783 | 25,404 |

### Example 5

A reaction mixture was prepared by blending 447 parts LMA, 352 parts SMA, and 2.9 parts DDM. The reaction mixture was heated to 120° C. A monomer addition mixture consisting of 344.5 parts LMA, 187 parts of SMA, 1.95 parts DDM and 5.2 parts t-butyl peroctoate (50% in odorless mineral spirits) was added at a constant rate over 1.5 hours. The reaction temperature was decreased to 105° C. at the end of the addition of the monomer mixture and an initiator solution consisting of 2.6 parts t-butyl peroctoate (50% in odorless mineral spirits) and 25 parts 100N polymerization oil was fed at a constant rate over 30 minutes. The reaction mixture was held one hour after completion of the initiator addition, than diluted with 2052.6 parts of 100N oil. The composition of materials formed starts at about 56.5% LMA, 43.5% SMA and ends at about 63.5% LMA, 36.5% SMA. The polymer produced had a weight average molecular weight of about 105,000 (as determined by gel permeation chromatography (GPC), using poly(alkylmethacrylate) standards) and a polydispersity of about 2.35.

U.S. provisional patent application 60/949,279, filed Jul. 12, 2007, is incorporated herein by reference.

Numerous modifications and variations on the present invention are possible in light of the above teachings. It is therefore to be understood that within the scope of the appended claims, the invention may be practiced otherwise than as specifically described herein.

1. A process for preparing a continuously variable composition copolymer in a reaction system, comprising:
(a) providing a reaction vessel comprising a first monomer composition;
(b) providing a feed vessel comprising a second monomer composition;
(c) initiating a polymerization reaction in said reaction vessel;
(d) continuing the polymerization reaction during the gradual addition of said second monomer composition from said feed vessel to said reaction vessel, wherein the gradual addition of the second monomer composition is performed such that said continuously variable composition copolymer is obtained;
(e) maintaining said polymerization until at least 90% of the total monomer composition has been converted to said copolymer;
wherein said copolymer has a weight average molecular weight from 10,000 to 1,000,000;
wherein said copolymer is soluble in lubricating oil,
wherein the monomers of said first monomer composition provided in the reaction vessel comprise at least 50% by weight of all the monomers used to prepare said copolymer.

2. The process according to claim 1, wherein a polymerization reaction temperature is maintained in the range from 85 to 130° C.

3. The process according to claim 1, wherein the reaction system comprises only one monomer feed vessel from which the second monomer composition is added to the reaction vessel.

4. The process according to claim 1, wherein only one second monomer composition is added to the reaction vessel.

5. The process according to claim 1, wherein a weight ratio of said first monomer composition to said second monomer composition is within the range of 20:1 to 1:1.

6. The process according to claim 1, wherein a sum of the monomers of said first monomer composition and said second monomer composition comprises at least 80% by weight of all the monomers used to prepare said copolymer.

7. The process according to claim 1, comprising adding an initiator to the reaction vessel in two or more steps.

8. The process according to claim 1, comprising adding an initiator to the reaction vessel as a separate continuous feed stream that starts when the reaction vessel containing the first monomer composition reaches a desired reaction temperature.

9. The process according to claim 1, comprising adding an initiator to the reaction vessel; wherein a feed rate of the initiator increases in discreet steps over the course of the polymerization reaction.

10. The process according to claim 1, comprising adding an initiator to the reaction vessel; wherein part of the initiator is included in the second monomer composition.

11. The process according to claim 1, comprising adding an initiator to the reaction vessel; wherein a total amount of initiator is in the range from 0.05 to 0.5% by weight, based on a total amount of monomers used to prepare the copolymer.

12. The process according to claim 1, comprising adding an initiator to the reaction vessel; wherein an amount of initiator added to the polymerization reaction before addition of the second monomer composition is in the range of 0.2 to 10% by weight, based on the total amount of initiator.

13. The process according to claim 1, wherein an addition rate of the second monomer composition is constant during the addition of said second monomer composition to the reaction vessel.

14. The process according to claim 1, wherein an addition rate of the second monomer composition is increased or decreased during the addition of said second monomer composition to the reaction vessel.

15. The process according to claim 1, wherein a reaction temperature is lowered by 0° C. to 20° C. after completion of the addition of the second monomer composition.

16. The process according to claim 1, wherein a stirring rate in the reaction vessel is in the range from 50 to 500 rpm.

17. The process according to claim 1, wherein the contents of the reaction vessel is stirred by using a one or more pitched blade turbines.

18. The process according to claim 1, wherein the first monomer composition comprises at least two monomers.

19. The process according to claim 1, wherein the initiating of the polymerization reaction in said reaction vessel is achieved by addition of a free radical initiator.

20. The process according to claim 1, wherein a concentration of at least one monomer component of the first monomer composition differs by at least 5% from the concentration of the same monomer component in the second monomer composition.

21. The process according to claim 1, wherein an initial composition of copolymer produced is equivalent to the first monomer composition and comprises no more than 50% of the total copolymer composition.

22. The process according to claim 1, wherein the instantaneous composition of copolymer produced is equivalent to the composition of unreacted monomer present at that moment in the polymerization reaction.

23. The process according to claim 1, wherein an average copolymer composition can be defined by the equation:
X_{avg}=Σ(Xₙ*Wₙ)/ΣWₙ
wherein
Xₙ is the weight percent of each individual monomer (X) in each monomer composition (n), and
Wₙ is the total weight of monomer (X) in that monomer composition (n);
wherein n is an integer.

24. The process according to claim 1, wherein a range of copolymer compositions are produced and the copolymer can be defined as a differing from its nearest most similar copolymer by at least 1% in at least one monomeric component.

25. The process according to claim 1, wherein a weight percent of each individual copolymer composition comprises no more than 50% or the total copolymer composition.

26. The process according to claim 1, wherein a weight percent of each individual copolymer composition comprises no more than 20% or the total copolymer composition.

27. The process according to claim 23, wherein a range of copolymer compositions produced can be estimated as ranging between:
X_{avg}+[X_{avg}−X₁] and X_{avg}−[X_{avg}−X₁]
wherein [X_{avg}-X₁] is an absolute value of a difference between a starting composition and an average composition for monomer X.

28. The process according to claim 1, wherein said first monomer composition and/or said second comprises a solvent.

29. The process according to claim 28, wherein the solvent is petroleum base oil or synthetic oil.

30. The process according to claim 1, wherein said first monomer composition and said second comprises a chain transfer agent.

31. The process according to claim 30, wherein said first monomer composition comprises at least 0.05% by weight of the chain transfer agent.

32. The process according to claim 30, wherein said second monomer composition comprises at least 0.05% by weight of the chain transfer agent.

33. The process according to claim 1, wherein an addition rate of the second monomer composition to the reaction vessel is adapted according to the conversion rate of the monomer composition being present in the reaction vessel.

34. The process according to claim 33, wherein the conversion rate is controlled by an initiator feed.

35. The process according to claim 33, wherein the conversion rate is controlled by the reaction temperature.

36. The process according to claim 1, wherein the monomers present in the first and the second monomer composition are one or more monomers selected from the group consisting of vinylaromatic monomers, nitrogen-containing ring compound monomers, α-olefins, vinyl alcohol esters, vinyl halides, vinyl nitrites, (meth)acrylic acid derivatives, maleic acid derivatives and fumaric acid derivatives.

37. The process according to claim 36, wherein the (meth)acrylic acid derivatives are one or more (meth)acrylic acid derivatives selected from the group consisting of methyl methacrylate, butyl methacrylate, isodecyl methacrylate, lauryl-myristyl methacrylate, dodecyl-pentadecyl methacrylate, cetyl-eicosyl methacrylate and cetyl-stearyl methacrylate.
